(19) United States
(12) Patent Application Publication
(10) Pub. No.: US 2015/0198513 A1
(43) Pub. Date: Jul. 16, 2015

(54) METHOD OF CRITICAL DISPLACEMENT FORECAST BASED ON THE DEFORMATION FAILURE MECHANISM OF SLOPE

(71) Applicant: Hubei university of technology, Wuhan (CN)

(72) Inventors: Ying-Fa LU, Wuhan (CN); De-Fu LIU, Wuhan (CN)

(21) Appl. No.: 14/596,025

(22) Filed: Jan. 13, 2015

(30) Foreign Application Priority Data
Jan. 13, 2014 (CN) 201410014057.7

(51) Int. Cl. G01N 3/24

(52) U.S. Cl. CPC G01N 3/24

(57) ABSTRACT

In a method of critical displacement forecast based on the deformation failure mechanism of slope, a sliding surface displacement, a calculation based on status stability factors and a slope surface displacement are determined, and applied for forecast based on a thrust-type slope deformation mechanism, a key compartment division, a relation between stress and strain mechanics properties of sliding surface of geo-material, and an analysis of evolution characteristics at different points of the sliding surface. The method provides advantages of determining deformation values at different points of a sliding surface, a slope body and a slope surface during slope failures; describing the process of a progressive failure, deformations and force changes of a slope; combining slope monitoring values to perform the stability analysis and the calculation of the magnitude of the stability factors in different deformation statuses of the slope; and assessing the durability of protective measures to the slope.

### CROSS-REFERENCE TO RELATED APPLICATION

This application claims the benefit of China Patent Application No. 201410014057.7, filed on Jan. 13, 2014, in the State Intellectual Property Office of the People's Republic of China, the disclosure of which is incorporated herein in its entirety by reference.

### BACKGROUND OF THE INVENTION

1. Field of the Invention

The present invention relates to a slope forecast and warning technology, and more particularly to a method of critical displacement forecast based on the deformation failure mechanism of slope.

2. Description of the Related Art

Slope forecast is still a difficult technical problem remained to be solved properly, and the present methods for determining critical displacements of the deformation failure are still imperfect. In slope failures, displacements at different positions vary. As to different slopes, the deformation mechanism is also different. In general, the critical displacement and the critical deformation rate in the conventional slope forecast and warning did not point out the critical displacement and critical deformation rate at a particular position of the slope.

### SUMMARY OF THE INVENTION

Therefore, it is a primary objective of the present invention to provide a method of critical displacement forecast based on the deformation failure mechanism of slope, and to provides a method of determining sliding surface displacement, a calculation based on displacement status stability factors and a slope surface displacement of a slope, based on a thrust-type slope deformation mechanism, a key compartment division, a relation between stress and strain mechanics properties of sliding surface of geo-material, and an analysis of evolution characteristics at different points of the sliding surface.

To achieve the aforementioned objective, the present invention provides a method of critical displacement forecast based on the deformation failure mechanism of slope, wherein a sliding surface displacement, calculation based on a status stability factors of a displacement and a slope surface displacement are determined and applied for forecast and warning based on a thrust-type slope deformation mechanism, a key compartment division, a relation between stress and strain mechanics properties of sliding surface of geo-material, and an analysis of evolution characteristics at different points of the sliding surface.

The method of critical displacement forecast based on the deformation failure mechanism of slope of the present invention comprises the following steps:

1. Analyze fundamental morphology and characteristics of a slope, perform an experiment to obtain basic physical and mechanical parameters G, S, m, ρ, C, φ, a₁, a₂, a₃, and ξ_{N} of a sliding surface and a sliding body, calculate a displacement field and a stress field, and determine a stability factors by the stress field.

2. Substitute the parameters obtained from Step (1) into the Equation τ=Gγ[1+γ^{m}/S]^{ρ}, where τ and γ are a shear stress and a shear strain of a material respectively, τ and G are in a unit of MPa or kPa or Pa, and S, m and ρ are parameters with no unit, and −1<ρ≦0 and 1+mρ≠0. Wherein, a critical stress space τ^{peak} is described by the Mohr-Coulomb Criteria τ^{peak}=C+σₙ tan φ, wherein C is cohesion, σₙ is normal stress, C and σₙ are in unit of MPa, kPa or Pa, and φ is sliding-surface friction angle, and a critical strain space γₚₑₐₖ is described by the Equation (γₚₑₐₖ/a₃)²−((σₙ−a₂)/a₁)^{ξ}_{N}=1, in which σₙ is normal stress in unit of MPa, kPa or Pa, and a₁, a₂, a₃ and ξ_{N} are the constant coefficients obtained by experiment; the critical stress space and the critical strain space have a relation of τ^{peak}/γₚₑₐₖ=G[1−1/(1+mρ)]^{ρ}, and the critical strain space complies with the equation of S+(1+mρ)γ^{m}ₚₑₐₖ=0; the parameter ρ=ρ₀/(1+(ρ₀/ρ_{c}−1)(σₙ/σₙ^{c})^{ζ}), in which ρ₀ is the value that the normal stress (σₙ) is zero, ρ_{c} is the value that σₙ is equal to σₙ^{c} and ζ is constant.

3. Calculate the displacement at different points of the sliding surface by using the critical strain space at the different points of the sliding surface obtained from Step (2).

4. Calculate the stress field of the sliding surface and the sliding body produced by the corresponding strain change by using the displacement at the different points of the sliding surface obtained from Step (3), and calculate a corresponding strain field and a corresponding stress field during the slope failure to obtain a displacement value at the failure of the sliding surface, which is equal to a displacement value of the different points of the sliding surface during the slope failure, and use the physical and mechanical parameters of the slide body to calculate different displacement values of the slope body and slope surface.

A status stability factor Fₛ is calculated by the stability factors obtained from Step (1), in which a displacement vector sum S_{c-t} at a whole failure of the slope is divided by a displacement vector sum Sₚ₋ₜ measured at a status state, and the stability factors exist in three directions of the X-axis, Y-axis and Z-axis are Fₛ₋ₓ=S_{c-t}^{x}/Sₚ₋ₜ^{x}, F_{s-y}=C_{c-t}^{y}/Sₚ₋ₜ^{y}, and F_{s-z}=S_{c-t}^{z}/Sₚ₋ₜ^{z} respectively.

The displacement values of the slope body and slope surface is calculated by obtaining a variation relation Sₘ from the sliding surface displacement and the slope surface displacement by applying a monitoring data analysis in situ, and the variation relation Sₘ is represented by a height (h) related parabolic curve Sₘ=Sᵢ+b₂h+b₃h², wherein b₂ and b₃ are constant coefficients, so as to obtain the displacement values of the slope body and slope surface.

The displacement values at different points of the sliding surface are obtained from a reverse calculation by applying a measured data of the slope body and the slope surface, so as to perform a feedback forecast and warning.

The method of critical displacement forecast based on the deformation failure mechanism of slope in accordance with embodiments of the present invention has the following advantages and effects:

1. The method may determine the deformation values at different points of a sliding surface, a slope body and a slope surface in a slope failure.

2. The method may describe the process of a progressive failure, deformations and force changes of a slope.

3. The method may combine the conventional slope monitoring values to perform the stability analysis and calculation of the magnitude of the stability factors of the slope at different deformation states.

4. The method may combine a deformation history to assess the durability of protective measures to a slope.

### BRIEF DESCRIPTION OF THE DRAWINGS

FIG. 1 is a schematic view showing the process of progressive failure and evolution of a slope;

FIG. 2, part (a) is a characteristic curve of an evolution at different points of a sliding surface in a specific time period;

FIG. 2, part (b) is a curve of load-displacement, mechanical classification and stable status of a sliding surface of a slope;

FIG. 2, part (c) is a curve of deformation at different points in the same period;

FIG. 2, part (d) is a curve of evolution of a progress slope failure at a specific time period;

FIG. 3 is a time characteristic curve of a sliding surface;

FIG. 4 is a time characteristic curve of different points of a sliding surface at the time approaching the failure; and

FIG. 5 is a displacement relation curve of a two-dimensional sliding surface.

Wherein, T is a load, T^{Peak} is a load at peak, T^{yield} is a load at yield limit, T^{resid} is a residual load, P^{peak} is a load point at peak, P^{yield} is a load point at yield limit, P^{resid} is a residual load point, Pₐ, P_{b} and P_{c} are different load points; S is a displacement, S^{peak} is a displacement at peak point, S^{yield} is displacement at yield limit point, S^{resid} is a displacement at residual point, H is height, and t is time.

### DETAILED DESCRIPTION OF THE PREFERRED EMBODIMENTS

The technical characteristics, contents, advantages and effects of the present invention will be apparent with the detailed description of a preferred embodiment accompanied with related drawings as follows. The drawings are provided for the illustration, and same numerals are used to represent respective elements in the preferred embodiments. It is intended that the embodiments and drawings disclosed herein are to be considered illustrative rather than restrictive. Same numerals are used for representing same respective elements in the drawings.

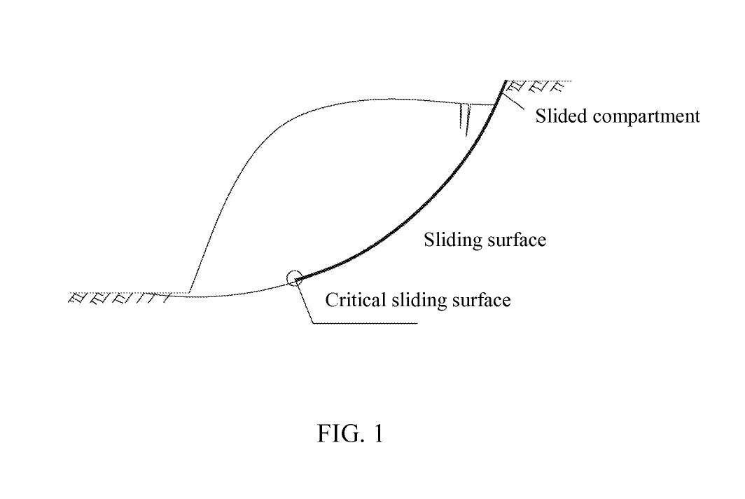

In a deformation mechanism of a thrust-type slope, the thrust-type slope generally cracks or breaks at a posterior end first. As time goes by and washing by rain with the evolution of geo-material strength, the cracking surface gradually moves from top to bottom. The middle of the slope will be uplifted and bulged after the deformation is accumulated to a specific level. At specific time, the front of the slope will be of failure, and finally the whole slope will be of failure. In the whole evolution process, the slope has only one point (or one curve) in a two-dimensional plane (or a three-dimensional plane) of the sliding surface of the slope is situated at a peak stress status (which is the critical stress status) and the remaining points are situated at a residual stress status or a status before the peak stress status. The progressive failure evolution process of the slope is shown in FIG. 1.

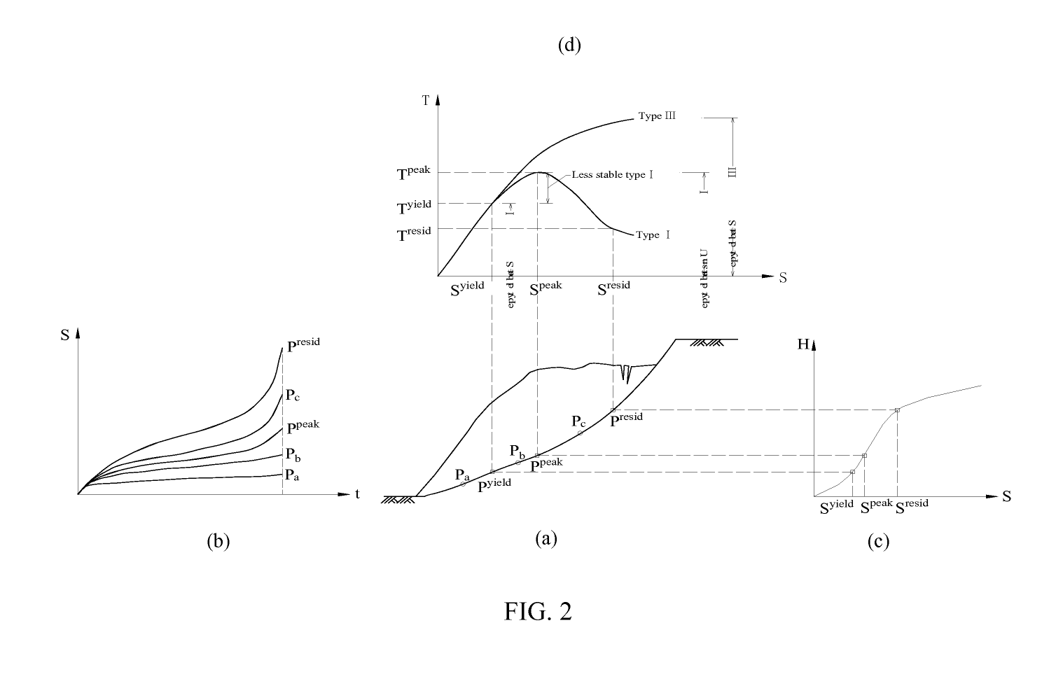

In the compartment division of a slope at different statuses, the physical and mechanical properties of a sliding surface of the slope comply with the curve characteristics of the load and displacement of geo-materials. Thus, it is necessary to categorize the stabilities of a slope compartment at different stages. If the load-displacement relation curve of a slope compartment is situated at a Type I status and the compartment is situated at a status before the load at yield limit, then the compartment will be defined as stable. If the compartment is situated at a status between the load at the yield limit and the peak load, then the compartment will be defined as lack-of-stability. If the compartment is situated at a status after the peak load, then the compartment will be defined as unstable. If the load-displacement relation of the compartment is situated at a Type III status, the compartment will be defined as stable. Please refer to FIG. 2, part (d) for a division of the stabilities of the slope compartment. According to the division of the stabilities of the slope compartment, the key compartments are the compartment situated at a load status before a yield limit and the compartment showing a Type III characteristic in the load-displacement relation curve of the slope compartment. The key compartments of a slope in situ are the compartments with a very small deformation at a sliding-resisting section and the compartment located at an anti-warping section at the front of the slope, etc.

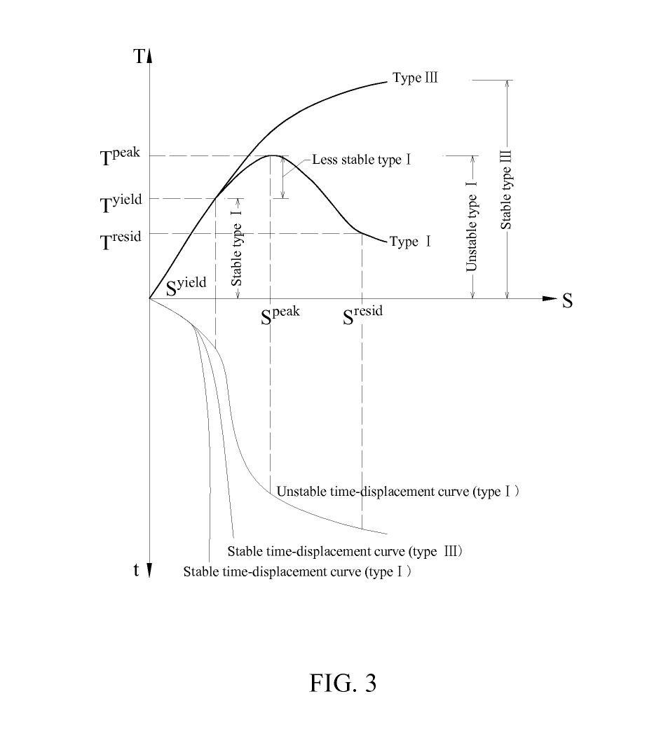

In the division of time and deformation characteristic curve, the division of the compartments obviously shows that the mechanical properties of the compartment not just relate to the stress status where the compartment is located only, but also relate to the deformation status of the compartment. Therefore, the deformation of slope and the transmission of forces are closely correlated and indispensable to each other. As to every point on the sliding surface of the slope, the time and displacement relation curve complies with the mode as shown in FIG. 3. If the point of a sliding surface is situated at a Type I status and has gone through the Type I stable status, lack-of-stability status and unstable status, such point will show the characteristics of a type I unstable curve. If the point of a sliding surface is situated at the Type I status and has just gone through the Type I stable status, such point will show the characteristics of a Type I stable curve. If the point of a sliding surface is situated at a Type III status, such point will show the characteristics of a Type III stable curve. These characteristics are related to the characteristics of the load-displacement curve of the geo-materials.

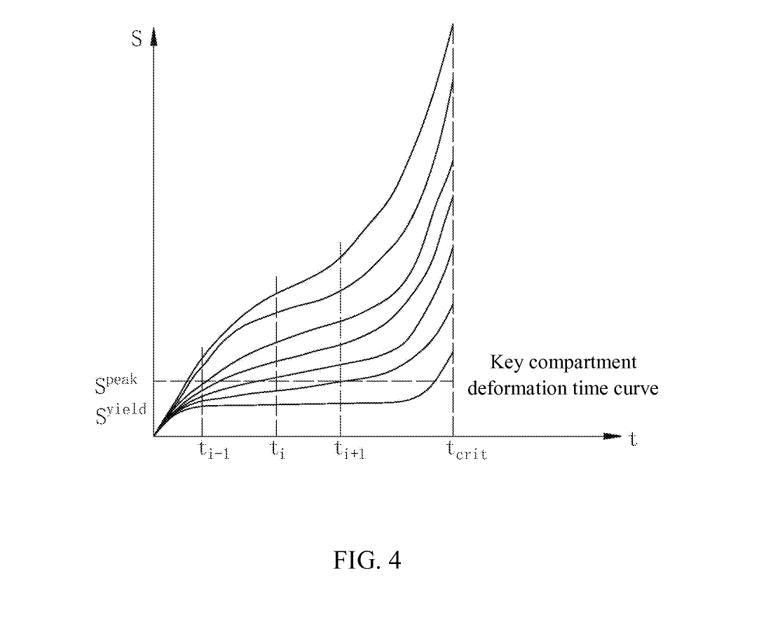

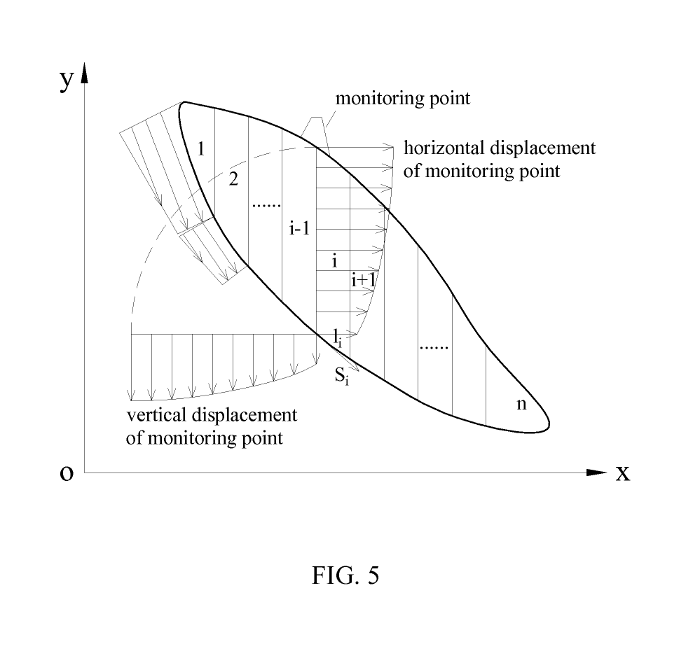

As to the evolution characteristics of time and displacement at different points of a slope, the different points on the sliding surface of the slope comply with the characteristics of the curve at a specific time as shown in FIG. 3, so that the whole sliding surface will comply with the characteristics of the time curve. In other words, different points on the sliding surface comply with the characteristics of the curve at the same time period as shown in FIG. 2, part (c). In the time period t₁, different points (such as Pₐ, P_{b}, P^{peak}, P_{c}, and P^{resid}) will comply with the characteristic of the curve as shown in FIG. 2, part (a). In a progressive changing process as shown in FIG. 2, part (a), the critical status point of the sliding surface is evolved from top to bottom. In the process of a slope failure, each point has experienced the critical status. A point exists in the sliding surface, and after such point (or a curve) has experienced the critical status, the whole slope will be failed. The compartment corresponding to this point (or curve) is called a key compartment, and the displacement corresponding to the key compartment is called a critical displacement. If a slope is about to have a failure, the time curve at different points of the sliding surface will show the characteristics as shown in FIG. 4. If the measurements are taken at different time points (such as tᵢ₋₁, tᵢ, and tᵢ₊₁), the curve characteristics of time and displacement will comply with the characteristics of the evolution occurred after that time period as shown in FIG. 4.

The method of critical displacement forecast based on the deformation failure mechanism of slope of the present invention comprises the following steps:

1. Analyze fundamental morphology and characteristics of a slope, perform an experiment to obtain basic physical and mechanical parameters G, S, m, ρ, C, φ, a₁, a₂, a₃, and ξ_{N} of a sliding surface and a sliding body, calculate a displacement field and a stress field, and determine a stability factors by the stress field.

2. Substitute the parameters obtained from Step (1) into the Equation τ=Gγ[1+γ^{m}/S]^{ρ}, where τ and γ are a shear stress and a shear strain or a shear-like stress and a shear-like strain of a material, respectively, T and G are in a unit of MPa or kPa or Pa, and S, m and ρ are parameters with no unit, and −1<ρ≦0 and 1+mp≠0.

A critical stress space τ^{peak} is described by the Mohr-Coulomb Criteria, τ^{peak}=C+σₙ tan φ, wherein C is cohesion, σₙ is normal stress, C and σₙ is in unit of MPa, kPa or Pa, and φ is sliding-surface friction angle, or other criteria are adopted.

A critical strain space γₚₑₐₖ is described by the Equation (γₚₑₐₖ/a₃)²−((σₙ−a₂)/a₁)^{ξ}_{N}=1, wherein a₁, a₂, a₃ and ξ_{N} are constants obtained by experiment, σₙ is normal stress in the unit of MPa, kPa or Pa.

The critical stress space and the critical strain space have a relation of τ^{peak}/γₚₑₐₖ=G[1−1/(1+mρ)]^{ρ}, and the critical strain space complies with the equation S+(1+mρ)γ^{m}ₚₑₐₖ=0. Wherein, the parameter ρ=ρ₀/(1+(ρ₀/ρ_{c}−1)(σₙ/σₙ^{c})^{ζ}), ρ₀ is the value that the normal stress (σₙ) is equal to zero, ρ_{c} is the value that the σₙ is equal to σₙ^{c}, and ζ is constant. The four parameters can be determined by experiments.

3. The displacement at different points of the sliding surface is calculated by using the critical strain space at the different points of the sliding surface obtained from Step (2).

4. The displacements at the different points of the sliding surface obtained from Step (3) may be used to calculate a corresponding strain field and a corresponding stress field, and this calculation may be conducted till the slope failure. The stability factors provided by the present invention may be used to obtain the displacement values at the failure of the sliding surface (which are the displacement values at different points of the sliding surface in a slope failure). In the meantime, the physical and mechanical parameters of the slide body may be used to calculate different displacement values of the slope body and slope surface.

The measured data of the slope body and slope surface may be used to obtain the failure and displacement values of different points of the slope surface.

The method of the present invention may use a measured value of the current slope for a reverse calculation to determine the current critical unit or critical compartment so as to perform a feedback forecast and warning.

The status stability factor Fₛ is calculated by dividing the displacement vector sum S_{c-t} measured at the whole failure of the slope by the displacement vector sum Sₚ₋ₜ measured at the status state, and the stability coefficients exist in three directions of the X-axis, Y-axis and Z-axis are Fₛ₋ₓ=S_{c-t}^{x}/Sₚ₋ₜ^{x}, F_{s-y}=S_{c-t}^{y}/Sₚ₋ₜ^{y}, and F_{s-z}=S_{c-t}^{z}/Sₚ₋ₜ^{z}, respectively.

As to the method of determining the displacements of the slope body and the slope surface, conventional numerical analysis may be adopted; particularly, a method of determining the boundary of a sliding surface disclosed in embodiments of the present invention may be adopted. Data measured in situ may also be used for the determination. For example, a inclinometer may be used to detect a variation relation Sₘ from the sliding surface and the slope surface displacement, and such relation can be described by using a height h related parabolic curve Sₘ=Sᵢ+b₂h+b₃h².

What is claimed is:

1. A method of critical displacement forecast based on the deformation failure mechanism of slope, comprising the steps of:
(1) analyzing fundamental morphology and characteristics of a slope, performing an experiment to obtain basic physical and mechanical parameters G, S, m, ρ, C, φ, a₁, a₂, a₃, and ξ_{N} of a sliding surface and a sliding body, calculating a displacement field and a stress field, and determining a stability factors by the stress field;
(2) substituting the parameters obtained from Step (1) into the Equation τ=Gγ[1+γ^{m}/S]^{ρ}, where τ and γ are a shear stress and a shear strain of a material respectively, τ and G are in unit of MPa or kPa or Pa, and S, m and ρ are parameters with no unit, and −1<ρ≦0 and 1+mρ≠0;
wherein a critical stress space τ^{peak} is described by the Mohr-Coulomb Criteria, τ^{peak}=C+σₙ tan ρ, wherein C is cohesion, σₙ is normal stress, C and σₙ is in unit of MPa, kPa or Pa, and φ is sliding-surface friction angle;
wherein a critical strain space γₚₑₐₖ is described by the Equation (γₚₑₐₖ/a₃)²−((σₙ−a₂)/a₁)^{ξ}_{N}=1, wherein σₙ is normal stress in unit of MPa, kPa or Pa, wherein a₁, a₂, a₃ and ξ_{N} are constants obtained by experiment, σₙ is normal stress in the unit of MPa, kPa or Pa;
wherein the critical stress space and the critical strain space have a relation of τ^{peak}/γₚₑₐₖ=G[1−1/(1+mρ)]^{ρ}, and the critical strain space complies with the equation of S+(1+mρ)γ^{m}ₚₑₐₖ=0;
wherein the parameter ρ=ρ₀/(1+(ρ₀/ρ_{c}−1)(σₙ/σₙ^{c})^{ζ}), in which ρ₀ is the value that the normal stress σₙ is equal to zero, ρ_{c} is the value that the σₙ is equal to σₙ^{c}, and ζ is constant;
(3) calculating the displacement at different points of the sliding surface by using the critical strain space at the different points of the sliding surface obtained from Step (2); and
(4) calculating the stress field of the sliding surface and the sliding body produced by the corresponding strain change by using the displacement at the different points of the sliding surface obtained from Step (3), and calculating a corresponding strain field and a corresponding stress field during the slope failure to obtain a displacement value at the failure of the sliding surface, which is equal to a displacement value of the different points of the sliding surface during the slope failure; and using the physical and mechanical parameters of the slide body to calculate different displacement values of the slope body and slope surface.

2. The method of critical displacement forecast based on the deformation failure mechanism of slope as claimed in claim 1, wherein a status stability factor Fₛ is calculated by the stability factors obtained from Step (1), in which a displacement vector sum S_{c-t} at a whole failure of the slope is divided by a displacement vector sum Sₚ₋ₜ measured at a status critical state, and the stability factors exist in three directions of the X-axis, Y-axis and Z-axis are Fₛ₋ₓ=S_{c-t}^{x}/Sₚ₋ₜ^{x}, F_{s-y}=S_{c-t}^{y}/Sₚ₋ₜ^{y}, and F_{s-z}=S_{c-t}^{z}/Sₚ₋ₜ^{z} respectively.

3. The method of critical displacement forecast based on the deformation failure mechanism of slope as claimed in claim 1, wherein the displacement values of the slope body and slope surface in the step (4) is calculated by obtaining a variation relation Sₘ from the sliding surface displacement and the slope surface displacement by applying a monitoring data analysis in situ, and the variation relation Sₘ is represented by a height related parabolic curve Sₘ=Sᵢ+b₂h+b₃h², wherein b₂ and b₃ are constant coefficients, so as to obtain the displacement values of the slope body and slope surface.

4. The method of critical displacement forecast based on the deformation failure mechanism of slope as claimed in claim 1, wherein the displacement values at different points of the sliding surface is obtained from a reverse calculation by applying a measured data of the slope body and the slope surface, so as to perform a feedback forecast and warning.
